(19) United States
(12) Patent Application Publication
(10) Pub. No.: US 2019/0073852 A1
(43) Pub. Date: Mar. 7, 2019

(54) BIREFRINGENT BANKNOTE FILM

(71) Applicant: Innovia Films Limited, Wigton, Cumbria (GB)

(72) Inventors: Alastair Hugh Servante, Wigton, Cummbria (GB); Robert Stewart, Wigton, Cummbria (GB)

(21) Appl. No.: 15/767,111

(22) PCT Filed: Oct. 27, 2016
(86) PCT No.: PCT/GB2016/053340

§ 371 Date: Apr. 9, 2018

(30) Foreign Application Priority Data
Oct. 30, 2015 (GB) 1519247.9

(51) Int. Cl. G07D 7/12; B32B 27/32; B42D 25/36; C09D 175/06

(52) U.S. Cl. CPC G07D 7/12; B32B 27/32; B42D 25/36; B32B 2554/00; B32B 2255/00; B32B 2307/42; B32B 2307/75; C09D 175/06

(57) ABSTRACT

A birefringent ink-printable banknote film comprising a birefringent polyolefinic substrate and a printable coating on at least one major surface of the birefringent polyolefinic substrate, the printable coating comprising: a polymeric binder; and an ethylenically unsaturated compound dispersed with or bonded to the polymeric binder, wherein said ethylenically unsaturated compound is able to form a covalent bond with an ink to render the film ink-printable.

The present invention concerns birefringent banknote films, in particular films carrying ink printable coatings which render the banknote films substantially more robust in terms of ink fastness than conventional polymeric banknote films and yet whilst still permitting such films to be authenticated by virtue of their birefringent characteristics.

Polymeric banknote films have been known for many years and have proved widely successful in a multiplicity of jurisdictional markets. However, local variations in the way in which banknotes are treated by consumers raises particular challenges as concerns the robustness and longevity in the marketplace of these materials, in particular with regard to the appearance of the printed ink.

In addition, the evolution of polymeric banknotes has included an increase in the size and complexity of the windows in the banknote films. In particular, more complex security features may be present in the windows, for example soft emboss features and foil features. The increased window size and more complex security features also raise particular challenges as concerns the robustness and longevity of polymeric banknotes in the marketplace.

The increasing use of polymeric film materials in the banknote industry may in part at least be ascribed to certain advantages exhibited by polymeric films over the more traditional paper-based materials as regards anti-counterfeiting measures. One property of such materials which is useful in that respect is birefringence, as has been described at length in our publications WO2009/133390, WO2012/032361, WO2014/060362, WO2014/181086, WO2014/181087, WO2014/181088, WO2014/181089 and WO2014/181090. Many of these documents contain detailed descriptions of various types of polymer films, their methods of manufacture, and of the property of birefringence as it pertains to such films, and methods of and uses for its measurement, and the contents of each of these documents is incorporated herein by reference.

These prior art disclosures have focused on birefringence detection. However, they pay scant attention to the mechanical, chemical and environmental stresses and strains to which banknotes are subject in circulation. In the present invention attention is paid as to how to manufacture and provide authentifiable polymeric banknote films which exhibit birefringent properties and yet which are highly robust as far as ink adhesion is concerned.

Printable coatings for polymeric films are known in the art.

WO97/27064 describes a printable film comprising a substrate and at least a surface layer, said layer covering at least one face of said substrate and comprising a water-dispersible polymer and an ethylenically unsaturated compound.

WO2010/067111 describes a primer-less coating composition for facestock, comprising: a binder being a water-dispersible polymer; an ethylenically unsaturated compound which is aqueous-dispersible and miscible with or bonded to said water-dispersible polymer, wherein said ethylenically unsaturated compound is able to form a covalent bond with an ink; and a crosslinker, wherein said crosslinker is suitable for binding the coating to the facestock.

US2002/146559 describes plastic substrates which are coated with a printable coating composition layer which comprises: an anionic acrylic polymer; and epoxy acrylate in an amount sufficient to improve ink adhesion in said coating composition.

One aim of this invention is to address the problem of ink fastness in printed banknote films which may be subjected to harsh treatment in circulation, for example coming into contact with all manner of contaminants and placed under various mechanical strains. Poor ink adhesion is significantly detrimental to such products, causing banknotes to deteriorate in situ and reducing the allowable residence time of such notes in circulation.

Another aim of this invention is to address the challenges regarding the robustness and longevity of polymeric banknotes which include large windows and/or complex security features in the windows.

According to a first aspect of the present invention there is provided a birefringent ink-printable banknote film comprising a birefringent polyolefinic substrate and a printable coating on at least one major surface of the birefringent polyolefinic substrate, the printable coating comprising: a polymeric binder; and an ethylenically unsaturated compound dispersed with or bonded to the polymeric binder, wherein said ethylenically unsaturated compound is able to form a covalent bond with an ink to render the film ink-printable.

The invention further provides a birefringent ink-printable banknote film which is authentifiable by means of its retardation signal and which comprises a birefringent polyolefinic substrate exhibiting a retardation signal within an authentifiable range and a printable coating on at least one major surface of the birefringent polyolefinic substrate, the printable coating comprising: a polymeric binder; and an ethylenically unsaturated compound dispersed with or bonded to the polymeric binder, wherein said ethylenically unsaturated compound is able to form a covalent bond with an ink to render the film ink-printable, the retardation signal of the film being at least partly within the authentifiable range of the polyolefinic substrate retardation signal.

By ‘birefringent’ we mean a property wherein a material has controlled, engineered or inherent birefringence sufficient to allow the property of its birefringence to be used to determine authenticity or otherwise of the material displaying the birefringent property, for example as described in any of our publications WO2009/133390, WO2012/032361, WO2014/060362, WO2014/181086, WO2014/181087, WO2014/181088, WO2014/181089 and WO2014/181090.

The inventors of the present invention have surprisingly found that a birefringent ink-printable banknote film can be formed from a birefringent polyolefinic substrate having a printable coating on at least one major surface thereof. This is unexpected since the printable coating may be non-birefringent, birefringent to a different degree from the substrate, or birefringent to the same degree as the substrate, and it is surprising that the presence of the coating still permits the birefringent properties of the substrate to be determined and compared with a nominal reference standard successfully to establish the authenticity or otherwise of the banknote film.

Advantageously, birefringent ink-printable banknote films according to the present invention can be authenticated using known birefringence measurement techniques, such as those described in WO2014/060362, WO2014/181086, WO2014/181087, WO2014/181088, WO2014/181089 and WO2014/181090.

The inventors of the present invention have also surprisingly found that the presence of the printable coating may increase the adhesion of complex security features, for example soft emboss features and foil features, to the banknote film particularly in any window portion(s) of the banknote film.

The presence of the printable coating may also improve the optical properties of the film, particularly the optical properties of any window portion(s) in the banknote film, for example the haze may be reduced. The improvement in optical properties may mean that the use of optical-improving additives, which may be deleterious to the longevity of the banknote film, can be reduced or eliminated.

According to another aspect of the present invention, there is provided a method of authenticating birefringent ink-printable banknote film as described above comprising detecting if a substrate portion of the film located in a measuring region of an authentication apparatus has a predetermined birefringence characteristic, and further comprising the steps of: determining, by an item detection arrangement, if at least a substrate portion of the film is located in a measuring region of an authentication apparatus; comparing a measured birefringence characteristic, obtained by an optically-based birefringence measuring apparatus, with a predetermined birefringence characteristic of the substrate portion of the film; and producing an authenticity signal indicative of authenticity or otherwise of the item based upon the comparison.

According to another aspect of the present invention, there is provided a method for determining the authenticity of a birefringent ink-printable banknote film as described above, comprising:
providing an optically-based birefringence measuring apparatus
exposing the film in the apparatus to a light source having wavelength or range of wavelengths;
measuring an effect influenced by a birefringence characteristic of the film responsive to said light source;
comparing the measured effect with a value or range of values representative of a specified effect corresponding to a predetermined birefringence characteristic of an authentic polymer film responsive to the light source; and
outputting an authenticity signal indicative of authenticity or otherwise of the film based upon the comparison.

The birefringent ink-printable banknote films referred to herein are films which can be directly printed with ink, i.e. a film in which the printable coating is strong enough to resist the pull of a tacky ink.

The birefringent polyolefinic substrate may comprise any suitable polyolefinic material, for example polyethylene, polypropylene, polybutylene and/or mixtures, blends or copolymers (e.g. bipolymers, terpolymers) thereof. Preferably, the birefringent polyolefinic substrate comprises polypropylene. More preferably, the birefringent polyolefinic substrate comprises oriented polypropylene. Yet more preferably, the birefringent polyolefinic substrate comprises biaxially oriented polypropylene (BOPP).

The birefringent polyolefinic substrate may comprise a single layer or multiple layers. Where the birefringent polyolefinic substrate comprises multiple layers, it may include a core layer and one or more skin layers. Preferably, the birefringent polyolefinic substrate comprises a core layer with a skin layer on either side thereof.

The core and/or skin layer(s) may comprise any one or more of the previously listed polyolefinic materials.

As a specific example, the birefringent polyolefinic substrate may comprise a core layer comprising polypropylene, and a skin layer on either side of the core layer comprising a propylene-ethylene-butylene terpolymer, a propylene-ethylene copolymer, a propylene-butylene copolymer and/or an ethylene-butylene copolymer.

The polyolefinic substrate may be made by any process known in the art, including, but not limited to, cast sheet, cast film and blown film. The film may be prepared as a balanced film using substantially equal machine direction (MD) and transverse direction (TD) stretch ratios. Alternatively, the film may be prepared as an unbalanced film, where the film is significantly more oriented in one direction (MD or TD).

Sequential stretching can be used to form the film, for example heated rollers may effect stretching of the film in the MD and an oven may be used thereafter to effect stretching in the TD. Alternatively, simultaneous stretching, for example using the so-called bubble process (performed by Innovia Films Limited, Wigton UK) or simultaneous Stenter stretching, may be used.

The printable coating is provided on at least one major surface of the birefringent polyolefinic substrate (the birefringent polyolefinic substrate having two major surfaces).

The printable coating may be provided on only one of the major surfaces of the birefringent polyolefinic substrate. The resulting banknote film may be referred to as a ‘one-side coated’ film.

Alternatively, the printable coating may be provided on both major surfaces of the birefringent polyolefinic substrate. The resulting banknote film may be referred to as a ‘two-side coated’ film. Two-side coated films may be preferred since the benefits resulting from the printable coating in terms of ink adhesion, can be realised on both surfaces of the banknote film.

It should be noted that the printable coating is not necessarily directly adjacent the major surface(s) of the birefringent polyolefinic substrate, as there may be intervening layers located therebetween.

The printable coating comprises a polymeric binder and an ethylenically unsaturated compound dispersed with or bonded to the polymeric binder.

Advantageously, the polymeric binder provides the printable coating with a smooth, film-formed and ink-receptive surface.

Preferably, the polymeric binder is a water dispersible polymer. By way of non-limiting example, the polymeric binder may be selected from water dispersible acrylics, acrylates, urethanes, urethane acrylates, styrene butadiene/maleic anhydride copolymers and/or mixtures thereof.

Water dispersible acrylic polymers suitable as the polymeric binder comprise (co)polymers obtained by the free-radical addition polymerisation of at least one (meth)acrylic type monomer and optionally of other vinylic or allylic compounds. For example, suitable water dispersible acrylic polymers comprise homopolymers of (meth)acrylic acid or alkyl (meth)acrylate, the alkyl radical having from 1 to 10 carbon atoms, or copolymers of two or more of the said (meth)acrylic type monomers and optionally of other vinylic or allylic compounds.

As stated above, a water dispersible urethane polymer may also suitably be used as the polymeric binder. For example, suitable water dispersible urethane polymers comprise the reaction product of an isocyanate-terminated polyurethane prepolymer formed by reacting at least an excess of an organic polyisocyanate, an organic compound containing at least two isocyanate-reactive groups and an isocyanate-reactive compound containing anionic salt functional groups (or acid groups which may be subsequently converted to such anionic salt groups) or non-ionic groups and an active hydrogen-containing chain extender.

The polymeric binder may be present in the printable coating in an amount of from about 10% to about 98%, from about 60% to about 95%, or from about 74% to about 92% by weight of the printable coating (in the present specification, all percentages are dry weight based).

The ethylenically unsaturated compound is dispersed with or bonded to the polymeric binder.

The ethylenically unsaturated compound may be provided as a distinct component in the printable coating. Additionally or alternatively, the ethylenically unsaturated compound may be provided as part of the polymeric binder itself, for example as a functional side chain of the polymeric binder.

Preferably, the ethylenically unsaturated compound contains 1 to 10 double bonds per molecule and still more preferably 2 to 5 double bonds per molecule (or per functional group in the event that the compound is provided as a pendant side chain from, or otherwise as part of, the polymeric binder e.g. a water dispersible polymeric binder).

Suitable ethylenically unsaturated compounds include the ester derivatives of α, β-ethylenically unsaturated acids, such as acrylic or methacrylic acids, itaconic or citraconic acids, maleic or fumaric acids, with polyols or alkyoxylated polyols. Other suitable ethylenically unsaturated compounds include derivatives of isocyanate prepolymers or oligomers reacted with ethylenically unsaturated alcohols and ethoxylated variants thereof, such as Desmodur™ (Bayer) trifunctional isocyanate reacted with hydroxyl ethyl methacrylate. In other words, ethylenically unsaturated compounds used in accordance with the present invention may comprise one or more urethane linkages in addition to, or instead of, one or more ester linkages.

Suitable polyols include saturated aliphatic diols such as ethylene glycol, diethylene glycol, triethylene glycol, propylene glycol, dipropylene glycol, tripropylene glycol, butylene glycol, neopentyl glycol, 1,3-butane diol, 1,4-butane diol, 1,5-pentane diol, 1,6-hexanediol and 2-methyl-1,3-propanediol. Glycerol, 1,1,1-trimethylolpropane, bisphenol A and its hydrogenated derivatives may also be used. Suitable alkoxylated polyols include the ethoxylated or propoxylated derivatives of the polyols listed above.

Examples of ethylenically unsaturated compounds which can be used according to the invention include polyfunctional acrylates such as difunctional acrylates, for example 1,4-butane diol acrylate, 1,6-hexane diol diacrylate, neopentyl glycol diacrylate, triethylene glycol diacrylate, polyethylene glycol diacrylate, tripropylene glycol diacrylate, 2,2-dionol diacrylate, bisphenol A diacrylate; trifunctional acrylates, for example pentaerythritol triacrylate, trimethylolpropane triacrylate; and tetrafunctional acrylates.

It is to be understood that the methacrylate derivatives corresponding to these acrylate derivatives could also be used.

Moreover, it has been found that polyallyl derivatives such as tetraallyloxyethane are also suitable. Suitable material in this connection are commercially available under the trade name Ebecryl™ from Cytec Industries Inc.

The amount of the ethylenically unsaturated compound may be from about 2% to about 90%, from about 2% to about 15%, or from about 2% to about 10% by weight of the polymeric binder.

Advantageously, the ethylenically unsaturated compound is able to form a covalent bond with an ink to render the film ink-printable.

Optionally, the printable coating further comprises a crosslinker. The crosslinker is capable of binding the printable coating to the birefringent polyolefinic substrate and/or to a primer layer which may be situated between the printable coating and the birefringent polyolefinic substrate.

Advantageously, the crosslinker may improve the hardness and/or water resistance of the printable coating and consequently, of the banknote film, whilst resulting in a printable coating which, once hardened, allows the easy penetration of an ink, for example a radiation curable ink.

Suitable crosslinkers include carbodiimide and aziridine crosslinkers, and crosslinkers disclosed in WO 02/31016, for example.

These types of crosslinker have the additional advantage of effecting binding between the birefringent polyolefinic substrate and the printable coating, without compromising other qualities such as good printability. More specifically, it has been found that these types of crosslinker can be used to bind functional groups on the surface of the birefringent polyolefinic substrate with functional groups in the components of the printable coating, for example the crosslinker can form bonds between carboxyl, hydroxyl and/or amine functional groups at the interface between the birefringent polyolefinic substrate and the printable coating. These crosslinkers also provide the banknote film with water-resistance without excessively hardening the product, thereby meaning that the surface of the banknote film (i.e. the surface of the printable coating) can still be readily printed. In fact, improvements in printability may be seen.

In addition, where these types of crosslinker are used, it is possible to formulate the banknote film in the absence of a primer layer i.e. a separate layer which binds the birefringent polyolefinic substrate to the printable coating. This may be beneficial in terms of reduced manufacturing costs, less production equipment being required and an overall simpler manufacturing process.

Alternatively, the crosslinker may be a coordinating metal ligand which can form stable coordinated structures with carboxy or carbonyl functionality. For example, Ammonium zirconium carbonate (stabilised or not).

The crosslinker may be present in the printable coating in an amount of from about 1% to about 10%, from about 1% to about 5%, or from about 2% to about 5% by weight of the polymeric binder.

For example, where the polymeric binder is a water dispersible acrylic polymer (as previously described), the amount of crosslinker may be up to about 10% by weight of the acrylic polymer, or up to about 5% by weight of the acrylic polymer. Preferably, the amount of crosslinker is from about 1% to about 10%, from about 1% to about 5%, or from about 2% to about 5% by weight of the acrylic polymer.

The printable coating may comprise one or more additives, for example, for preventing the blocking of one sheet to another, and/or for improving the ink adhesion, surface hardness, sheet running property, antistatic property and/or non-transparency property. The one or more additives are generally added in a total amount not exceeding 40% by weight of the polymeric binder.

The one or more additives may be selected from polyethylene oxide, silica, silica gel, colloidal silica, clay, talc, diatomaceous earth, calcium carbonate, calcium sulfate, barium sulfate, aluminium silicate, synthetic zeolite, alumina, zinc oxide, titanium oxide, lithopone, satin white, and cationic, anionic and non-ionic antistatic agents.

The printable coating may be applied to the birefringent polyolefinic substrate as an aqueous dispersion.

The printable coating may be applied to the birefringent polyolefinic substrate at a coat weight of from about 0.5 g/m² to about 2.5 g/m².

The printable coating may be applied to the birefringent polyolefinic substrate using the method of roll coating, blade coating, spray coating, air knife coating, rod bar coating, gravure or reverse gravure.

Following application of the printable coating to the birefringent polyolefinic substrate, the printable coating may be dried, for example in a hot air oven.

Prior to applying the printable coating to the birefringent polyolefinic substrate, one or both major surfaces of the birefringent polyolefinic substrate may be pre-treated in a conventional manner with a view to improving the wetting and/or adhesiveness of the birefringent polyolefinic substrate. For example, the birefringent polyolefinic substrate may be pre-treated using corona discharge, flame treatment, plasma treatment such as modified dielectric barrier discharge (MADBD) treatment, and/or oxidising chemical treatment.

The birefringent ink-printable banknote film may further comprise a primer layer.

The primer layer, where present, is provided between the birefringent polyolefinic substrate and the printable coating to aid binding therebetween. Where a two-side coated banknote film is desired (as previously described), a primer layer may be provided between the birefringent polyolefinic substrate and each printable coating.

The primer layer may comprise polyethylene imine or polyurethane acrylate primers crosslinked by isocyanate, epoxy, aziridine or silane derivatives.

The primer layer may be applied to the birefringent polyolefinic substrate using conventional coating techniques, for example using a gravure roll coating method.

The primer layer may be conveniently applied as a dispersion or as a solution.

The primer layer may be applied as an aqueous dispersion. Aqueous dispersion techniques have the added advantage that there is no residual odour due to the solvent present, which may be the case when an organic solvent is used.

Alternatively, the primer layer may be applied from an organic solvent or dispersant. Examples of suitable organic solvents include alcohols, aromatic hydrocarbon solvents, such as xylene, or mixtures of such solvents.

The printable coating may carry an ink on its surface.

The ink may be applied to the surface of the printable coating using conventional printing techniques, for example, digital printing, ink-jet printing, intaglio printing, offset printing, gravure, flexography, screen process printing and letterpress printing.

Preferably, the ink used is a radiation curable ink. For example, the radiation curable ink may be a UV curable ink or an electron beam curable ink.

Following printing, the radiation curable ink is radiation cured.

The radiation curable ink generally comprises one or more pigments, vehicle, solvent and one or more additives. The solvents in these systems may be low-viscosity monomers, capable of reacting themselves i.e. used as reactive diluents. The vehicle may be composed of a resin derived from unsaturated monomers, prepolymers or oligomers such as acrylate derivatives which are able to react with the ethylenically unsaturated compound of the printable coating. For a UV curable ink, the one or more additives may comprise a large amount of photoinitiators which respond to the photons of UV light to start the system reacting.

A UV curable ink formulation may be generalised as follows:

| Component | Amount |
|---|---|
| Pigment | 15% to 20% |
| Prepolymer | 20% to 35% |
| Vehicle | 10% to 25% |
| Photoinitiator | 2% to 10% |
| Other additives | 1% to 5% |

For an electron beam curable ink, the additives generally comprise no photoinitiator.

The low viscosity monomers, sometimes termed diluents, are capable of chemical reaction which result in their becoming fully incorporated into the ultimate polymer matrix.

The vehicle provides the ‘hard resin’ portion of the formulation. Typically, these are derived from synthetic resins such as for example, urethanes, epoxides, polyesters which have been modified by reaction with compounds bearing ethylenic groups such as for instances (meth)acrylic acid, hydroxyethyl(meth)acrylate, reaction product of caprolactone with unsaturated compounds bearing a hydroxyl group, and the like.

Appropriate adjustments could be made in the selection of the prepolymers and monomers used in order to achieve the required viscosities for the different methods of application.

According to another aspect of the present invention there is provided a process for the manufacture of a birefringent ink-printable banknote film comprising the step of coating at least one major surface of a birefringent polyolefinic substrate with an aqueous dispersion comprising a polymeric binder and an ethylenically unsaturated compound, and further comprising the step of drying the coating to obtain a printable coating wherein the ethylenically unsaturated compound is able to form a covalent bond with an ink to render the film ink-printable.

For the avoidance of doubt, any of the features described herein may relate to any aspect of the invention, where appropriate.

The invention will now be more particularly described with reference to the following non-limiting figures and examples.

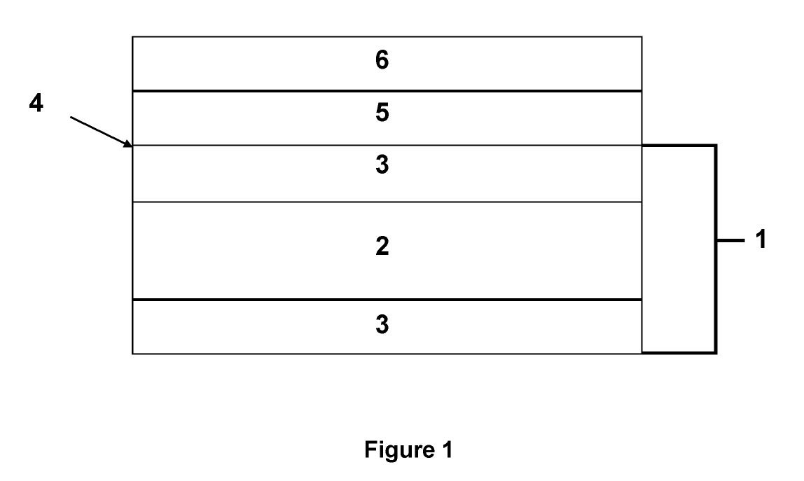

FIG. 1: a schematic diagram of a one-side coated birefringent ink-printable banknote film according to the present invention

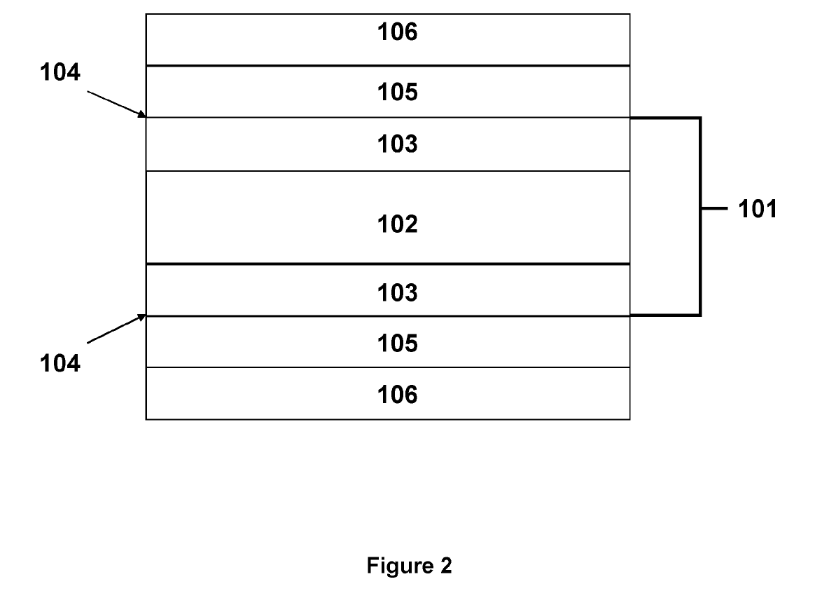

FIG. 2: a schematic diagram of a two-side coated birefringent ink-printable banknote film according to the present invention

FIG. 1 shows a schematic diagram of a one-side coated birefringent ink-printable banknote film. The banknote film comprises a birefringent polyolefinic substrate 1 having a core layer 2 and a skin layer 3 on either side of the core layer. The surface 4 of the birefringent polyolefinic substrate 1 is corona discharge treated to improve its adhesiveness. A primer layer 5 is provided on surface 4 of the birefringent polyolefinic substrate 1. A printable coating 6 comprising a polymeric binder and an ethylenically unsaturated compound dispersed with or bonded to the polymeric binder, is provided on the primer layer 5. The primer layer 5 aids binding between the birefringent polyolefinic substrate 1 and the printable coating 6.

FIG. 2 shows a schematic diagram of a two-side coated birefringent ink-printable banknote film. The banknote film comprises a birefringent polyolefinic substrate 101 having a core layer 102 and a skin layer 103 on either side of the core layer. Both surfaces 104 of the birefringent polyolefinic substrate 101 are corona discharge treated to improve adhesiveness. A primer layer 105 is provided on each surface 104 of the polyolefinic substrate 101. A printable coating 106 comprising a polymeric binder and an ethylenically unsaturated compound dispersed with or bonded to the polymeric binder, is provided on each of the primer layers 105. The primer layers 105 aid binding between the birefringent polyolefinic substrate 101 and the printable coatings 106.

### EXAMPLES

### Example 1

A polyolefinic substrate having a core layer of polypropylene and a skin layer of propylene-ethylene-butylene terpolymer on either side of the core layer, is formed using the bubble process. Each major surface of the polyolefinic substrate is corona discharge treated and subsequently primed on both surfaces at 0.2 g/m² with a polyurethane acrylate to which an isocyanate crosslinker is added prior to coating.

The primed surfaces of the polyolefinic substrate are overcoated with an aqueous dispersion containing 21.0 kg of an aliphatic polyester based polyurethane (DAOTAN VTW 1238 from HOECHST; solids content 50%) which represents 80.8% (dry weight) of the aqueous dispersion, 0.9 kg of tripropylene glycol diacrylate (solids content 100%; 7% (dry weight) of the aqueous dispersion), 1.1 kg of ammonium zirconium carbonate (solids content 20%; 1.7% (dry weight) of the aqueous dispersion), 4.3 kg of colloidal silica (LUDOX HS40 from DU POINT; solids content 30%; 10% (dry weight) of the aqueous dispersion) and 0.65 kg of silica gel as anti blocking agent (GASIL HP 250 from CROSFIELD; solids content 10%; 0.5% (dry weight) of the aqueous dispersion).

The coated film is then dried in a hot air over.

The coated film is then printed on both surfaces in a screen printing process with RSP series ink (from NORCOTE) at 12 g/m².

The printed film is then UV cured with a medium pressure mercury vapour lamp (120 W/cm) at 12.2 m/min.

### Example 2

A printed film is prepared as described in Example 1, except that the ethylenically unsaturated compound is replaced with triacrylate of ethoxylated trimethylpropane (EBECRYL™ 1160 from UCB, S.A.).

### Example 3

A printed film is prepared as described in Example 1, except that the urethane polymer is replaced with an anionic acrylic polymer (NEOCRYL XK-90 from ZENECA).

### Examples 4 to 6

Printed films are prepared as described in Example 2, except that the urethane polymer is replaced respectively with:

Example 4: an anionic acrylic polymer (NEOCRYL XK-90 from ZENECA)

Example 5: a styrene acrylic copolymer (GLASCOL LE 31 from ALLIED COLLOIDS)

Example 6: another anionic acrylic polymer (NEOTAC A-572 from ZENECA)

For each of the films of Examples 1 to 6, the adhesion of the radiation cured ink to the film is tested according to the following three procedures.

### Scratch Test—Boiling Water Condition

A waterbath is heated to 95° C. Once the temperature remains stable, the sample of the printed film to be tested is immersed into the water. After 45 minutes, the sample is removed from the waterbath and scratched with moderate pressure with a coin held square to the surface of the sample. The loss of print is reported as ‘pass’ or ‘fail’ wherein ‘pass’ means no loss of print and ‘fail’ means noticeable loss of print.

### Ink Removal—Boiling Water Condition

A waterbath is heated to 95° C. Once the temperature remains stable, the sample of the printed film to be tested is immersed into the water. After 45 minutes, the sample is removed from the waterbath. An adhesive tape is applied on the sample and then the adhesive tape is quickly removed. The surface percentage of ink removed (visual estimation) is reported.

### Scratch Test—Freezing Water Condition

A waterbath containing a mixture of ice and water (50:50) is cooled to 0° C. Once the temperature remains stable, the sample of the printed film to be tested is immersed into the water.

After 24 hours, the sample is removed from the waterbath and scratched with moderate pressure with a coin held square to the surface of the sample. The loss of print is reported as ‘pass’ or ‘fail’ in the same manner as described above.

The results for each of the examples are shown in Table 1.

TABLE 1

| | Boiling Water Condition | | Freezing Water |
|---|---|---|---|
| | | % Ink | Condition |
| Example | Scratch Test | Removal | Scratch Test |
| 1 | Pass | 0 | Pass |
| 2 | Pass | 0 | Pass |
| 3 | Pass | 0 | Pass |
| 4 | Pass | 0 | Pass |
| 5 | Pass | 0 | Pass |
| 6 | Pass | 0 | Pass |

From the results it can be seen that birefringent ink-printable banknote films according to the present invention exhibit strong adhesion to radiation cured inks, even after exposure to extreme conditions.

1. A birefringent ink-printable banknote film, comprising:
a birefringent polyolefinic substrate; and
a printable coating on at least one major surface of the birefringent polyolefinic substrate, the printable coating comprising:
a polymeric binder; and
an ethylenically unsaturated compound dispersed with or bonded to the polymeric binder, wherein said ethylenically unsaturated compound is able to form a covalent bond with an ink to render the film ink-printable.

2. The birefringent ink-printable banknote film according to claim 1, which is authentifiable by means of its retardation signal, wherein the birefringent polyolefinic substrate exhibits a retardation signal within an authentifiable range and wherein the retardation signal of the film is at least partly within the authentifiable range of the polyolefinic substrate retardation signal.

3. The birefringent ink-printable banknote film according to claim 1, wherein the birefringent polyolefinic substrate comprises a polyolefinic material selected from polyethylene, polypropylene, polybutylene and/or mixtures, blends or copolymers thereof.

4. The birefringent ink-printable banknote film according to claim 1, wherein the polyolefinic substrate comprises a core layer and one or more skin layers, preferably two skin layers.

5. The birefringent ink-printable banknote film according to claim 4, wherein the core layer comprises biaxially oriented polypropylene.

6. The birefringent ink-printable banknote film according to claim 4, wherein the one or more skin layers comprises a propylene-ethylene-butylene terpolymer.

7. The birefringent ink-printable banknote film according to claim 1, wherein the printable coating is provided on one major surface of the birefringent polyolefinic substrate.

8. The birefringent ink-printable banknote film according to claim 1, wherein the printable coating is provided on both major surfaces of the birefringent polyolefinic substrate.

9. The birefringent ink-printable banknote film according to claim 1, wherein the polymeric binder is a water dispersible polymer.

10. The birefringent ink-printable banknote film according to claim 9, wherein the water dispersible polymer is selected from water dispersible acrylics, acrylates, urethanes, urethane acrylates, styrene butadiene/maleic anhydride copolymers and/or mixtures thereof.

11. The birefringent ink-printable banknote film according to claim 1, wherein the polymeric binder is present in the printable coating in an amount of from about 10% to about 98%; from about 60% to about 95%; or from about 74% to about 92% by weight of the printable coating.

12. The birefringent ink-printable banknote film according to claim 1, wherein the ethylenically unsaturated compound is able to form a covalent bond with an ink to render the birefringent banknote film, ink-printable.

13. The birefringent ink-printable banknote film according to claim 1, wherein the ethylenically unsaturated compound is present in an amount of from about 2% to about 90%; from about 2% to about 15%; or from about 2% to about 10% by weight of the polymeric binder.

14. The birefringent ink-printable banknote film according to claim 1, wherein the printable coating further comprises a crosslinker.

15. The birefringent ink-printable banknote film according to claim 14, wherein the crosslinker is a carbodiimide crosslinker, an aziridine crosslinker, or a coordinating metal ligand which can form stable coordinated structures with carboxy or carbonyl functionality.

16. The birefringent ink-printable banknote film according to claim 14, wherein the crosslinker is present in the printable coating in an amount of from about 1% to about 10%; from about 1% to about 5%; or from about 2% to about 5% by weight of the polymeric binder.

17. The birefringent ink-printable banknote film according to claim 1, wherein prior to applying the printable coating, one or both major surfaces of the birefringent polyolefinic substrate is pre-treated using corona discharge, flame treatment, plasma treatment such as modified dielectric barrier discharge, and/or oxidising chemical treatment.

18. The birefringent ink-printable banknote film according to claim 1, wherein a primer layer is provided between the or each printable coating and the birefringent polyolefinic substrate.

19. The birefringent ink-printable banknote film according to claim 18, wherein the primer layer comprises polyethylene imine or polyurethane acrylate primers crosslinked by isocyanate, epoxy, aziridine or silane derivatives.

20. The birefringent ink-printable banknote film according to claim 1, wherein the printable coating carries an ink, optionally a radiation curable ink such as a UV curable ink or an electron beam curable ink.

21. A birefringent printed banknote severed from a web of the film according to claim 1.

22. A process for the manufacture of a birefringent ink-printable banknote film, comprising the step of:
coating at least one major surface of a birefringent polyolefinic substrate with an aqueous dispersion comprising a polymeric binder and an ethylenically unsaturated compound; and drying the coating to obtain a printable coating, wherein the ethylenically unsaturated compound is able to form a covalent bond with an ink to render the film ink-printable.
